(19) United States
(12) Patent Application Publication
(10) Pub. No.: US 2022/0341459 A1
(43) Pub. Date: Oct. 27, 2022

(54) FUNCTIONAL ADHESIVE MOUNTING APPARATUS SET

(71) Applicant: YATEK MARIN YAT MALZEMELERI SANAYI TICARET LIMITED SIRKETI, Istanbul (TR)

(72) Inventor: Adem AYDIN, Istanbul (TR)

(21) Appl. No.: 17/763,617

(22) PCT Filed: Mar. 19, 2020
(86) PCT No.: PCT/TR2020/050224

§ 371 Date: Mar. 24, 2022

(30) Foreign Application Priority Data
Sep. 25, 2019 (TR) 2019/14623

(51) Int. Cl. F16B 37/04; F16B 47/00

(52) U.S. Cl. CPC F16B 37/048; F16B 47/003

(57) ABSTRACT

The invention relates to a functional, adhesive mounting apparatus set for the mounting of products used in different sectors such as land, air and sea vehicles, home office and similar space decorations and medical products.

### TECHNICAL FIELD

The invention relates to a functional, adhesive mounting apparatus set for the mounting of products used in different sectors such as land, air and sea vehicles, home office and similar space decorations and medical products.

### STATE OF THE ART

In the state of the art, screws, snap fasteners and similar mounting elements are frequently used for mounting applications in different sectors. In these products, there are problems such as mounting difficulties, rusting, deformation and damaging the applied surface. Especially ball head screws used in the old system in the boats had to be mounted by drilling holes in the boat. This disadvantage caused the boat to be damaged. In addition, the old-style ball head screws used had to remain fixed on the boat after assembly. Hence, users could be exposed to injuries caused by this screw.

This system, which we have developed, can easily mount and remove the ball head screw in the products without any tools. We can prevent the users from getting damaged by replacing the removed screw with the dome cover.

Furthermore, there are adhesive snap fasteners specially produced considering the sea conditions frequently used in the current technique. These products can be used on wooden, fiber, glass and PVC surfaces developed to eliminate the problems caused by screw snap fasteners used in yachts. These products allow mounting of spring snap fasteners in snap fastener applications used in any industry without using screws. These products can be used easily for winter covers of boats and yachts, interior trims of land vehicles, interior trims of airline vehicles, interior trims of military vehicles, home decoration practices and mounting of medical product

### OBJECT OF THE INVENTION

Although the functional, adhesive mounting apparatus set according to the invention is used in mounting applications in boats and yachts, it is also suitable for the use of different products in different sectors thanks to the screw path inside the dome. Additionally, the flexibility slot in our product allows the product to be mounted on the uneven surfaces to be mounted. At the same time, thanks to the strong tape used in the product, it can be mounted without damaging the applied surface. The user can remove the ball head screw without needing any tools at any time and reassemble it at any time.

The installation of the dome cover prevents the users from being damaged.

It is aimed to mount different products in different sectors as well as mounting applications in land, air and sea vehicles with the functional, adhesive mounting apparatus set according to the invention.

It is aimed to make mounting applications faster and more practical with the functional, adhesive mounting apparatus set according to the invention.

It is aimed to prevent the damages that may occur on the surface desired to be mounted with the functional, adhesive mounting apparatus set according to the invention.

A practical, aesthetic and functional product is aimed by eliminating the problems and deficiencies in the present art with the functional, adhesive mounting apparatus set according to the invention.

### DESCRIPTION OF THE DRAWINGS

FIG. 1—Mounted view of the spring snap fastener of the functional, adhesive mounting apparatus set of the present invention.

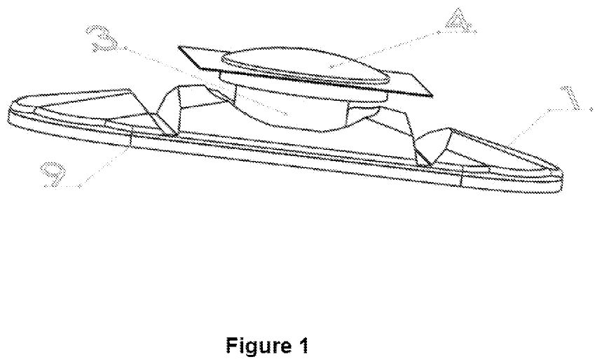

FIG. 2—Mounted view of the dome cover of the functional, adhesive mounting apparatus set of the present invention.

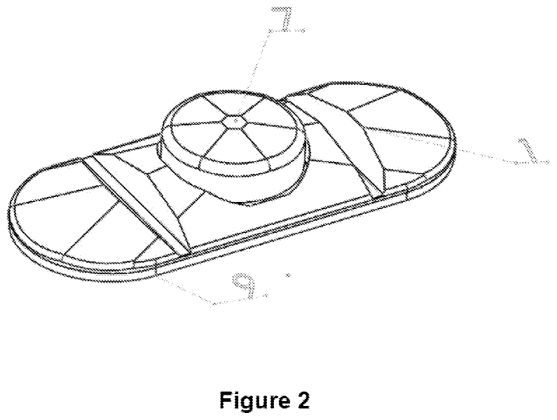

FIG. 3—Mounted view of the ratchet lock snap fastener of the functional, adhesive mounting apparatus set of the present invention.

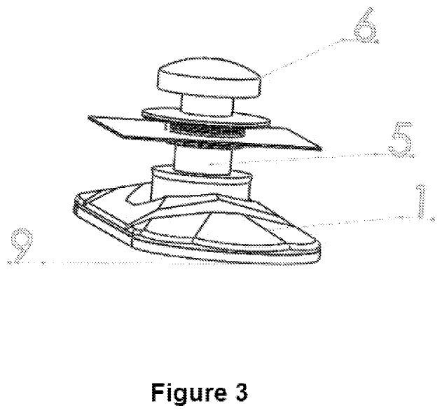

FIG. 4—View of the components of the functional, adhesive mounting apparatus set of the present invention.

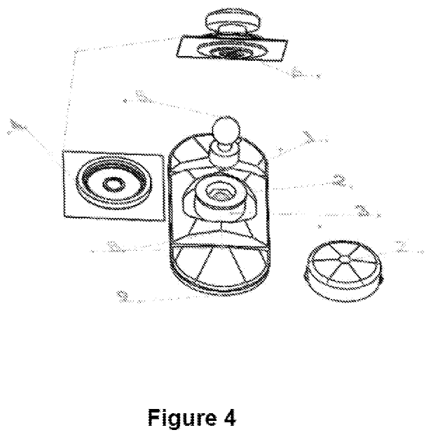

### DESCRIPTION OF THE REFERENCES IN THE FIGURES

1. Plastic body
2. Stainless steel nut
3. Dome (snap fastener slot)
4. Stainless steel spring snap fastener
5. Ball head (screw snap fastener bottom part)
6. Ratchet lock snap fastener
7. Dome (snap fastener slot) cover
8. Product flexibility slot
9. Double-sided tape

### DESCRIPTION OF THE DRAWINGS

The functional, adhesive mounting apparatus set of the present invention comprises; plastic body (1) which forms the main body of the product, stainless steel nut (2) which is used to attach different products and apparatus to the body (1), dome (3) used for mounting snap fasteners, stainless steel spring snap fasteners (4) for mounting to the dome (3) on the body (1), the bottom part of the ball head screw snap fastener (5) for mounting to the nut in the dome (3), ratchet lock snap fastener (6) mounted to the nut in the dome (3), dome cover (7) which is used to cover the dome (3) slot in the body (1), product flexibility slot (8) that allows the product to be installed on uneven and angled surfaces double-sided tape (9) which allows practical assembly of the body (1) without damaging the surface.

The plastic body (1) is made of delrin material. Stainless steel nut (2) varies according to the place of use. The dome (3) is the snap fastener (4) slot on the body (1). The snap fasteners (4) are made of stainless steel and vary according to the place of use and are assembled by combining with the dome (snap fastener slot) (3) on the body (1). Ball head screw snap fastener lower part (5) is made of yellow material with chrome or nickel coating. It is mounted to the nut (2) inside the dome (3). Ratchet lock snap fasteners (6) are made of yellow material with chrome or nickel coating. It can also be produced from stainless steel. It is mounted to the ball head snap fastener screw (5) with its spring lock system. The dome cover (7) is made of plastic delrin material. It is used to cover the dome (3) slot in the body (1). The product flexibility slot (8) allows the product to be mounted on uneven and angular surfaces by giving the product flexibility. The double-sided tape (9) allows practical assembly of the body (1) without damaging the floor.

### APPLICATION OF THE INVENTION ON THE INDUSTRY

The functional, adhesive mounting apparatus set of the present invention can be applied in different designs according to the preference and need in the mounting of the products used in different sectors.

1. A functional adhesive mounting apparatus set, comprising:
a plastic body;
a stainless steel nut;
a dome;
a stainless steel spring snap fastener;
a ball head;
a ratchet lock snap fastener;
a dome cover;
a product flexibility slot; and
double-sided tape.

2. The functional adhesive mounting apparatus set according to claim 1, the dome enables easy installation in different products.

3. The functional adhesive mounting apparatus set according to claim 1, wherein the stainless steel nut is configured to attach different products and apparatus to the body.

4. The functional adhesive mounting apparatus set according to claim 1, wherein the product flexibility slot enables the product to be installed on uneven and angled surfaces.
